(19) United States
(12) Patent Application Publication
(10) Pub. No.: US 2002/0024011 A1
(43) Pub. Date: Feb. 28, 2002

(54) Method for correcting opaque defects in reticles for charged-particle-beam microlithography, and reticles produced using same

(75) Inventor: Sumito Shimizu, Yokohama-shi (JP)

Correspondence Address: KLARQUIST SPARKMAN CAMPBELL LEIGH & WHINSTON, LLP, One World Trade Center, 121 S. W. Salmon Street, Suite 1600, Portland, OR, 97204-2988, US

(73) Assignee: Nikon Corporation

(21) Appl. No.: 09/944,045

(22) Filed: Aug. 30, 2001

(30) Foreign Application Priority Data
Aug. 30, 2000 (JP) 2000-260585

(51) Int. Cl. G21K 7/00; G01N 23/00

(52) U.S. Cl. 250/307

(57) ABSTRACT

Reticle-defect-correction methods are disclosed by which an “opaque” defect in a reticle, such as a scattering-stencil reticle, is corrected while ensuring good verticality in the side wall of the affected pattern element. A fabricated reticle, defining a pattern, is inspected to produce corresponding pattern-inspection coordinate data for the pattern. An opaque defect is detected from a comparison of the pattern-inspection data with corresponding design-specified data (e.g., CAD data) for the pattern. If an opaque error is found, a unit of a protective film (e.g., an FIB-induced film of a carbon and/or silicon compound) is formed along the edge of the affected pattern element adjacent the opaque defect. The unit of protective film protects the edge during subsequent correction machining, thereby preserving the verticality of the side wall of the affected pattern element.

### TECHNOLOGICAL FIELD

The relevant technical field pertains to microlithography (transfer of a pattern, defined on a reticle, to a “sensitive” substrate). Microlithography is a key technology used in the fabrication of microelectronic devices such as integrated circuits, displays, thin-film magnetic heads, micromachines, and the like. More specifically, this disclosure pertains to repairing reticles, especially reticles defining patterns transferred to a sensitive substrate by charged-particle-beam projection microlithography.

### BACKGROUND OF THE INVENTION

As noted above, microlithography is a key step used in the manufacture of integrated circuits and other microelectronic devices. Microlithography achieves the formation of fine circuit patterns on a suitable substrate such as a semiconductor wafer. The performance of the microelectronic devices ultimately formed on the substrate is determined in part by the number of active circuit elements (e.g., transistors) formed on the substrate. In general, the smaller the size of transistors and other active circuit elements that can be formed on the substrate, the greater the number of such elements that can be included in the device.

During recent years, remarkable progress has been achieved in manufacturing technology for integrated circuits and other microelectronic devices. These developments have allowed active circuit elements in the devices to be made progressively smaller and more highly integrated.

Microlithography is a key determinant of how small active circuit elements can be formed on a substrate. To date, the most commonly used microlithography technology is “optical” microlithography performed using ultraviolet light. Optical microlithography is limited, however, in its ability to resolve extremely fine pattern features. Because current demand is very high for integrated circuits comprising active circuit elements that are smaller than the limit of pattern resolution obtainable with an optical microlithography (“stepper”) machine, substantial effort is being expended to develop a “next generation” microlithography technology that can achieve greater resolution than optical steppers. Candidate microlithography technologies having reasonable prospects of meeting this goal are charged-particle-beam (CPB) microlithography (using an electron beam or ion beam) and X-ray microlithography.

Effort has been especially intense in the development of a practical microlithography technology capable of resolving active circuit elements having a line width of 0.1 μm or less. In this regard, an especially attractive candidate technology is the electron-beam (EB) “reduction” projection-exposure technique. This technique is termed “reduction” because the substrate is exposed with a pattern image, projected from a reticle, that is smaller (“reduced” or “demagnified”) than the corresponding pattern on the reticle. A key attraction of this technology is its potential ability to achieve a throughput sufficiently high to be used profitably for mass-production of memory chips. In this technology, the principal current approaches are the well-known PREVAIL (projection reduction exposure with variable-axis immersion lenses) and SCALPEL (scattering with angular limitation in projection electron-beam lithography) techniques, in which commercial EB steppers now are making their commercial debut. These EB steppers currently achieve transfer of patterns having line widths of 0.1 μm or less.

Prior to EB reduction projection-exposure, the main CPB microlithography technology was based on the so-called “direct-write” technique in which the pattern was formed directly on the wafer element-by-element without using a pattern-defining reticle. (This technique still is used for producing microlithography reticles.) In one type of direct-write technique, termed “cell projection,” each element of a pattern was formed on the wafer by passing the exposure beam through one or multiple simple, basic graphic apertures. Elements of different sizes and shapes were formed by superposition of the images of the apertures with each other in various configurations, similar to the conventional variable-shaped beam approach. In the EB reduction projection-exposure technique, in contrast, the pattern as defined on the reticle is divided into portions that are substantially larger than the basic graphic apertures used in direct-write. The portions are exposed individually by projection with demagnification from a reticle, similar to the reduction projection-exposure technique used in an optical stepper. Consequently, the EB reduction projection-exposure technique achieves a substantially higher throughput than direct-write methods.

The reticle configurations usually used with an EB stepper or with the PREVAIL technique are known as “scattering-stencil” and “scattering-membrane” reticles. A scattering-stencil reticle basically comprises an electron-scattering membrane supported on a grid of support struts. Pattern elements are defined by corresponding through-holes in the membrane. The electron beam passes readily through the through-holes. Hence, an electron beam incident to the membrane is transmitted by the through-holes without scattering. The electron beam incident on the membrane, on the other hand, is transmitted with substantial forward-scattering. Downstream of the reticle, the scattered electrons are blocked by a scatter-limiting aperture from reaching the wafer. Hence, substantially only the electrons transmitted through the through-holes reach the wafer surface. A scattering-membrane reticle basically comprises a thin membrane transmissive to an incident charged particle beam. The membrane usually is made of silicon nitride (SiNₓ) on which pattern elements are defined by corresponding portions (“scattering bodies”) of a thin CPB-scattering layer (e.g., tungsten (W) or chromium (Cr)) on the SiNₓ membrane.

During production of reticles, pattern defects inevitably arise. The principal types of defects are (1) defects due to corresponding portions of the electron scatterer (i.e., the membrane) being absent (“white” or “clear” defects) from where they should be, and (2) defects due to corresponding portions of the electron scatterer being present (“black” or “opaque” defects) where they should not be. With respect to stencil reticles, for example, clear defects are believed to arise from errors, occurring during reticle production, in resist-pattern writing in which corresponding portions of the resist-etching mask simply are missing. These missing portions are directly manifest as clear defects. Opaque defects are due to corresponding undesired portions of electron-scattering material that remain on the reticle during and after reticle production. For example, particles of dirt remaining on the reticle after resist patterning can cause opaque defects. I.e., an adhering dirt particle behaves as a corresponding portion of an etching mask remaining on removed parts of the resist pattern. Opaque defects also can arise from errors occurring during resist writing.

Because clear and opaque defects can arise during reticle manufacture, and can cause significant errors later when the reticle is used for projection microlithography, reticles typically are inspected using a defect-inspection apparatus. If a defect is discovered, the reticle usually is sidelined for repair (“correction”) of the defect before being released for use.

Various methods and apparatus have been proposed for correcting pattern defects on reticles. Methods and apparatus employing a focused ion beam (FIB) are generally regarded as the most effective. For example, for correcting an opaque defect, the currently preferred method involves etching away the culprit particle using a Ga-FIB (focused ion beam of gallium) focused to a spot having a diameter of a few nanometers. Proponents of this approach claim that etching performed by Ga-FIB while introducing an “enhancement gas” effectively repairs the defect while preventing re-adhesion of the culprit particle and improves machinability at the defect site. For correcting a clear defect, the currently favored approach is to discharge a suitable amount of a reactive gas in the vicinity of the clear defect while irradiating the defect with a Ga-FIB. The Ga-FIB reacting with molecules of the gas produces a deposit of FIB-induced film at the site of the defect, thereby repairing the defect.

When repairing an opaque defect at a site on an affected pattern element of a stencil reticle, the reticle membrane or particle at the site must be machined away by the ion beam so that, after machining, the pattern element has a desired contour. It also is highly desirable that the transverse section of the pattern element at the site have side walls that are as close to “vertical” as possible. According to current specifications, the angle of inclination of the side walls is 90°±0.5°. When performing conventional machining using a FIB to correct an opaque defect, however, the side wall of the reticle membrane at the site on the pattern element also is etched to a certain extent. This unwanted machining prevents meeting the angle specification for the side wall.

Therefore, there is a need for improved methods for correcting defects on any of several types of reticles used in CPB microlithography, including scattering-stencil reticles and scattering-membrane reticles.

### SUMMARY

In view of the shortcomings of conventional technology, as summarized above, an object of the invention is to provide, inter alia, improved methods for correcting reticles, especially opaque defects in CPB microlithography reticles. The reticles are corrected while preserving the verticality of side walls of the “affected” pattern elements (i.e., pattern elements at which opaque defects are located).

According to a first embodiment, a method is provided for correcting an opaque defect in a microlithography reticle that includes charged-particle-scattering regions and relatively non-scattering regions arranged relative to each other so as to define a pattern that can be projection-transferred to a substrate using a charged particle beam. The method comprises as step in which the location of an opaque defect on the reticle is detected. On the reticle, a unit of a protective film is selectively formed at a pattern element in which the opaque defect is located. The unit of protective film is situated relative to the defect so as to provide a mask protecting an adjacent edge of the charged-particle-scattering region defining the affected pattern element, while leaving the defect vulnerable to a “defect-removing influence” (typically FIB etching). While using the unit of protective film as a mask that defines a desired corrected contour for the edge of the affected pattern element, the opaque defect is exposed to the defect-removing influence so as to correct the opaque defect and restore the contour.

The unit of protective film can be left on the reticle after correcting the defect. Typically, such units exhibit an amount of charged-particle absorption sufficiently low such that, after correcting the opaque defect and as the reticle is being used in microlithography, the residual unit of protective film does not absorb incident charged particles and hence does not cause significant local heating of the reticle.

Alternatively, after the step of exposing the opaque defect, the unit of protective film can be removed from the reticle before using the reticle for microlithography.

The unit of protective film desirably is an electron-scattering material but a poor absorber of incident electrons. To such ends, the unit of protective film desirably comprises a material that is a silicon compound, a carbon compound, or a mixture of such compounds. In this instance the step of forming the unit of protective film comprises supplying, at the affected pattern element, a film-forming gas comprising a silicon-compound gas, a carbon-compound gas, or a mixture thereof, while irradiating with a focused ion beam or electron beam. The material can further include atoms of a metal such as one or more of gallium (Ga), gold (Au), tungsten (W), and other metals desirably having an atomic number of less than 80, at a concentration of less than 40 percent. (If the unit of protective film is left on the reticle after correcting the defect, then a maximum concentration of only a few percent is acceptable; on the other hand, if the unit of protective film is removed from the reticle after correcting the defect, then a maximum concentration of less than 40 percent is acceptable.) Applying a unit of protective film containing metal ions to the reticle can be performed by local reaction of a film-forming gas and an organometallic gas irradiated with a focused ion beam or electron beam. As noted above, the film-forming gas can comprise a silicon compound, a carbon compound, or a mixture thereof.

If the unit of protective film is made of a material comprising silicon, the unit can be applied to the reticle by local reaction of a first compound while irradiating with a focused ion beam or electron beam. In this instance the first compound can be selected from the group consisting of organosilanes, halosilanes, carboxysilanes, ketoximesilanes, and alkoxysilanes. Applying the unit of protective film also can involve local reaction of a second compound along with the first compound while irradiating with the focused ion beam or electron beam. For example, the second compound can be an organometallic gas.

If the unit of protective film is made of a material comprising carbon, the unit can be applied to the reticle by local reaction of a condensed polycyclic hydrocarbon while irradiating with a focused ion beam or electron beam. In this instance the unit of protective film can be applied by local reaction of an organometallic gas along with the condensed polycyclic hydrocarbon, while irradiating with the focused ion beam or electron beam.

Another embodiment is directed to a method for correcting an opaque defect in a scattering-stencil reticle. The reticle includes an electron-scattering membrane in which non-scattering through-holes define respective pattern elements of a pattern. In a first step an opaque defect on the reticle is detected, wherein the opaque defect extends from the membrane into a respective through-hole of a respective affected pattern element. A unit of a protective film is selectively formed on the membrane at the affected pattern element. The unit of protective film is situated relative to the opaque defect so as to provide a mask protecting an edge and side wall of the membrane at the respective through-hole defining the affected pattern element while leaving the opaque defect vulnerable to a defect-removing influence. While using the unit of protective film as a mask that defines a desired corrected contour for the edge and side wall, the opaque defect is exposed to the defect-removing influence so as to correct the opaque defect and the contour of the membrane of the pattern element.

As noted above, the unit of protective film can comprise a material selected from the group consisting of silicon compounds, carbon compounds, and mixtures thereof. The material can further comprise atoms of a metal such as one or more of Ga, W, Au, and other metals desirably having an atomic number of less than 80, at a concentration of less than 40 percent.

The unit of protective film desirably is formed having a width, inward from the edge of the membrane, of at least 0.1 μm, a length of at least 1.5 times the length of the defect, and a thickness at least equal to the depth to which edge rounding would occur if the unit of protective film were not present while exposing the defect to a defect-removing influence.

Another embodiment of the methods is directed to a method for correcting a reticle used in a charged-particle-beam microlithography method in which a pattern is defined by a scattering-stencil reticle including an electron-scattering membrane in which non-scattering through-holes define respective elements of the pattern. In a first step, the pattern as defined on the reticle is inspected to produce respective defect-inspection data for the elements of the pattern as defined on the reticle. The defect-inspection data is compared with respective design-specified coordinate data for the elements of the pattern. For an affected pattern element producing defect-inspection data significantly different from respective design-specified coordinate data for the element, an opaque defect is identified in the pattern element and a machining size is determined that would be required to correct the defect. A unit of a protective film is selectively formed at the affected pattern element. The unit of protective film is formed relative to the opaque defect so as to provide a local mask protecting an edge and side wall of the membrane at the respective through-hole defining the affected pattern element while leaving the opaque defect vulnerable to defect-correction machining. Then, defect-correction machining of the opaque defect is performed.

This method can further comprise the step, after performing defect-correction machining, of confirming correction of the defect. The method can further comprise the step, after performing defect-correction machining, of washing the reticle.

Also encompassed by the invention are reticles in which opaque defects have been corrected using any of the subject methods.

In any event, opaque defects are corrected while ensuring good verticality in the transverse section of affected pattern elements. Also, correction machining is performed in a more stable and more accurate manner than conventionally.

Since the material of which the protective film is made exhibits relatively low electron absorption, if the film is left on the reticle after correcting the defects, electrons of an illumination beam as irradiated on the reticle during microlithography are not absorbed by the reticle. Thus, the reticle does not exhibit high local heating at the site of the unit when the reticle is irradiated with a high-acceleration electron beam after defect correction. The material of the protective film also is formulated to have a high etching resistance. Good candidate materials are any of various compounds including silicon and carbon.

The foregoing and additional features and advantages of the invention will be more readily apparent from the following detailed description, which proceeds with reference to the accompanying drawings.

### BRIEF DESCRIPTION OF THE DRAWINGS

FIG. 1 is an oblique view illustrating a reticle-defect-correction method according to a representative embodiment involving a scattering-stencil reticle.

FIG. 2((a)) is an elevational section (SIM or scanning ion microscope image) of a silicon membrane etched by focused ion beam (FIB) milling.

FIG. 2(b) is an elevational section (SIM image) of a silicon membrane machined by gas-assisted FIB etching.

FIG. 3 is an oblique view illustrating a reticle-defect-correction method according to a representative embodiment involving a scattering-membrane reticle.

### DETAILED DESCRIPTION

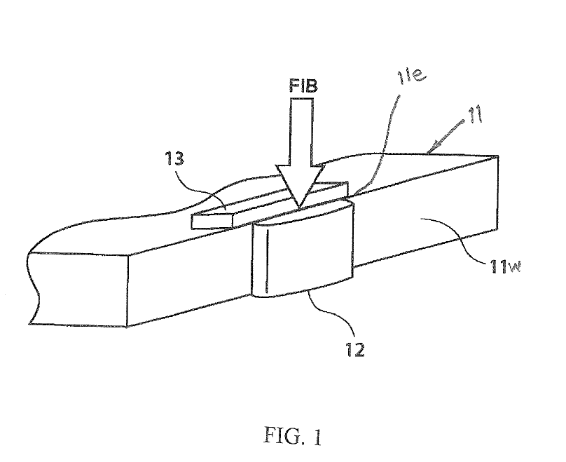

A first representative embodiment of a reticle-defect-correction method is depicted in FIG. 1, which shows an opaque (“black”) defect 12 extending from a side wall 11w of the reticle membrane 11 at a site in a pattern element. As discussed above, the reticle membrane 11 (usually made of silicon with a thickness of about 0.5 to 3.0 μm) of a scattering-stencil reticle is an electron “scatterer.” The opaque defect 12 also is an electron scatterer. Before machining the defect 12, a unit of protective film 13 is formed relative to the defect 12 so as to mask the edge 11e of the reticle membrane 11 in the vicinity of the defect 12. The film 13 placed in this manner prevents damage to the reticle membrane 11 by the FIB during subsequent irradiation of the defect 12 by the FIB. By protecting the edge 11e, the verticality of the side wall 11w is maintained even after the defect 12 has been removed.

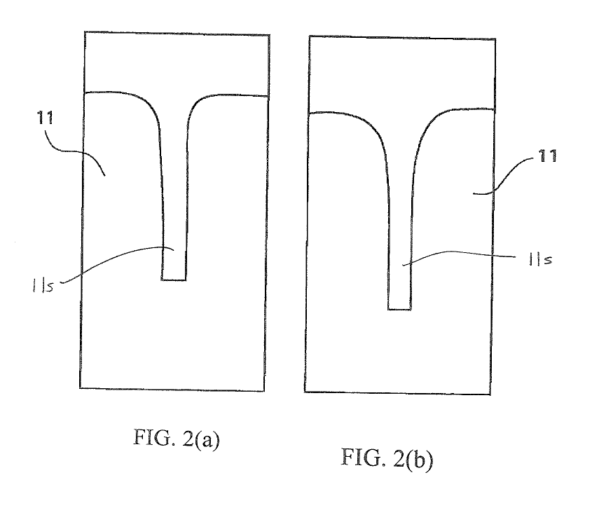

FIG. 2(a) is an elevational section of a silicon membrane 11 as visualized using scanning ion microscopy (SIM). The membrane 11 in FIG. 2(a) is shown after machining using only a FIB. Similarly, FIG. 2(b) is a SIM image of the elevational section of a silicon membrane 11 that has been machined by gas-assisted FIB etching. The FIB in both instances was incident from above in the figures. The width of the machined slit 11s in each instance is about 0.3 μm. As can be seen in FIGS. 2(a)-2(b), considerable rounding of the upstream edges (beam-incidence edges) of the slit 11s has occurred.

In deriving the present methods, various approaches for preventing edge rounding were investigated. One approach involved FIB machining using a FIB propagating toward the reticle at a non-normal angle, as disclosed in Japan Kôkai Patent Document No. 2000-100714. Unfortunately, using this technique, if the beam-incidence trajectory is tilted at a locus where the pattern element is extremely narrow (e.g., at a contact hole or the like), the incident FIB also will strike a side wall or edge of the pattern element located opposite the repair site. This causes a local increase in the width of the pattern element on the opposite side of the pattern element. Also, the particular rounding of the upstream edge 11e of a pattern element that results from conventional use of a FIB to machine an opaque defect reflects the transverse shape of the FIB.

In contrast, using a reticle-defect-correction method according to this representative embodiment, the elevational configuration of the pattern element after corrective etching still meets reticle specifications. In other words, the desired plan profile (“contour”) of the pattern element is restored without compromising the elevational side-wall profile of the pattern element, regardless of the size or shape of the pattern element and regardless of the transverse profile of the incident FIB.

On a scattering-stencil reticle, the unit of protective film 13 desirably is of an electron-scattering material and is applied locally along the edge of the reticle membrane at the through-hole of the pattern element where the opaque defect is located. The unit of protective film 13 serves as an etching mask that protects the underlying region of the reticle membrane, as well as the edge and side wall of the reticle membrane at the site of the opaque defect. The unit of protective film desirably is applied to the site of the correction using a selective film-formation method such as FIB-induced film formation or EB-induced (electron-beam-induced) film formation.

The unit of protective film 13 desirably does not contain a substantial concentration (greater than 40 percent) of a “heavy” metal such as one or more of Au, Ga, W, and other metals desirably having an atomic number of less than 80. A heavy-metal containing film 13 would leave a heavy-metal-containing residue on the reticle membrane 11 after completing defect correction. During subsequent use of the reticle for performing microlithography, irradiation of the residue with a highly accelerated illumination electron beam would cause substantial local heating of the reticle membrane 11 at the irradiation site due to absorption by the heavy-metal atoms of electrons of the illumination beam. The amount of heating depends upon the thickness of the residue on which the illumination beam is incident, the concentration of heavy-metal atoms in the residue, the energy of the incident beam, and the duration of irradiation at the site. Also, the silicon membrane 11 acts as a thermal insulator that poorly conducts the heat away from the residue. This situation would cause the reticle to exhibit, when the site is illuminated for microlithography, substantial local thermal stress in the vicinity of where the unit of protective film 13 had been located.

In view of the foregoing, an especially desirable material for the unit of protective film 13 is a relatively light element (atomic number 14 or less) that either does not absorb electrons or absorbs electrons very poorly. In this regard, an exemplary material is carbon or silicon. Hence, after correcting the defect, when the region on the reticle at which the defect was corrected is irradiated with a highly accelerated charged particle beam for microlithography, substantially no local heating occurs at the region relative to other regions of the reticle.

The material of the film 13 can include a metal such as Au, W, and/or Ga, or other metal having an atomic number less than 80. (If the unit of protective film is left on the reticle after correcting the defect, then only a few percent is acceptable. On the other hand, if the unit of protective film is removed from the reticle after correcting the defect, then a concentration of generally less than 40% is acceptable.) In any event, if the protective film 13 includes metal, the atoms of the metal must be well dispersed in the film 13. An inadequate dispersion is characterized by, e.g., clumps of metal atoms in the film 13 that readily absorb electrons of an incident beam, heat up, and impart thermal stress to the reticle.

In view of the foregoing, the selectively formed film 13 desirably is made of a material of which the main component is carbon and/or silicon. These materials can be deposited readily in a selective manner at a target site on the reticle. For example, a film 13 made mostly of silicon is selectively formed at the desired site by local reaction of an appropriate organosilane gas.

Specific examples of organosilanes include: tetramethylsilane, trimethylethylsilane, and methylethylsilane. It is also possible to use a halosilane compound in which the hydrolysate is a halogen atom, a carboxysilane compound in which the hydrolysate is a carboxy group, a ketoximesilane compound in which the hydrolysate is a ketoxime group, an alkoxysilane compound in which the hydrolysate is an alkoxy group, or the like. Of these, alkoxysilane compounds are particularly favorable.

Specific examples of alkoxysilanes include methylmethoxysilane, methylethoxysilane, ethylmethoxysilane, ethylethoxysilane, phenylmethylmethoxysilane, phenylmethylethoxysilane, γchloropropylmethylmethoxysilane, γ-chloropropylmethylethoxysilane, γ-methacryloxypropylmethylmethoxysilane, γ-methacryloxypropylmethylethoxysilane, γ-mercaptopropylmethylmethoxysilane, γ-mercaptopropylmethylethoxysilane, γaminopropylmethylmethoxysilane, γ-aminopropylmethylethoxysilane, methylvinylmethoxysilane, methylvinylethoxysilane, γ-glycidoxypropylmethylmethoxysilane, γ-glycidoxypropylmethylethoxysilane, methyltrimethoxysilane, methyltriethoxysilane, methyltripropoxysilane, methyltributoxysilane, methyltris(2-methoxyethoxy)silane, ethyltrimethoxysilane, ethyltriethoxysilane, ethyltripropoxysilane, ethyltributoxysilane, ethyltris(2-methoxyethoxy)silane, propyltrimethoxysilane, propyltriethoxysilane, butyltrimethoxysilane, butyltriethoxysilane, hexyltrimethoxysilane, hexyltriethoxysilane, vinyltrimethoxysilane, vinyltriethoxysilane, vinyltris(2-methoxyethoxy)silane, phenyltrimethoxysilane, phenyltriethoxysilane, γ-chloropropyltrimethoxysilane, γ-chloropropyltriethoxysilane, 3,3,3-trifluoropropyltrimethoxysilane, 3,3,3 -trifluoropropyltriethoxysilane, γ-methacryloxypropyltrimethoxysilane, γ-methacryloxypropyltriethoxysilane, γ-aminopropyltrimethoxysilane, γ-aminopropyltriethoxysilane, γ-mercaptopropyltrimethoxysilane, γ-mercaptopropyltriethoxysilane, chloromethyltrimethoxysilane, chloromethyltriethoxysilane, N-β-aminoethyl-γ-aminopropyltrimethoxysilane, N-β-aminoethyl-γ-aminopropyltriethoxysilane, γ-glycidoxypropyltrimethoxysilane, γglycidoxypropyltriethoxysilane, (3,4-epoxycyclohexylmethyl)trimethoxysilane, (3,4-epoxycyclohexylmethyl)triethoxysilane, β-(3,4-epoxycyclohexylethyl)trimethoxysilane, β-(3,4-epoxycyclohexylethyl)triethoxysilane, tetramethoxysilane, tetraethoxysilane, tetrapropoxysilane, tetrabutoxysilane, 1,1-bis(trimethoxysilyl)ethane, 1,1-bis(triethoxysilyl)ethane, 1,2-bis(trimethoxysilyl)ethane, 1,2 -bis(triethoxysilyl)ethane, 1,3-bis(trimethoxysilyl)propane, 1,3-bis(triethoxysilyl)propane, 2,2-bis(trimethoxysilyl)propane, and 2,2-bis(triethoxysilyl)propane.

Suitable compounds for making a carbon-containing film are any of various condensed polycyclic hydrocarbons of which the main chain is benzene. Examples of such compounds are naphthalene, biphenylene, acenaphthylene, fluorene, phenalene, phenanthrene, anthracene, fluoranthene, acephenanthrylene, aceanthrylene, triphenylene, pyrene, chrysene, naphthacene, pleiadene, picene, perylene, pentaphene, and pentacene. Other suitable compounds are orthocondensed or peri-condensed polycyclic hydrocarbons, or the like.

Metal atoms (e.g., Au, Ga, or W, or other metal having an atomic number of less than 80) may be added to the silicon film or carbon film at a suitable concentration (see above) by supplying an organometallic gas with the reactive silicon- or carbon-containing gas used to form the silicon or carbon film. The organometallic gas desirably is supplied to the site of the defect via a separate conduit from that used to supply the silicon-containing or carbon-containing gas.

Whether the selectively formed film 13 is subjected to a treatment (e.g., for removing the film) upon completion of FIB etching depends upon the composition of the film. For instance, if the selectively formed film 13 consists substantially of light elements such as silicon or carbon, then the film 13 can remain on the reticle after completing FIB etching of the opaque defect(s). In other words, under such conditions, the film 13 need not be stripped off the reticle before using the reticle for microlithography. This is because the film 13 will not diminish the electron-scattering performance of the underlying electron scatterer 11. Also, the amount of heat generated in such a film 13 from absorption of incident electrons is about the same as the amount of heat generated in the underlying electron scatterer 11 from electron absorption; hence, any residual film 13 consisting substantially of silicon or carbon poses no problem in this regard.

On the other hand, if the selectively formed film 13 includes a significant concentration of metal atoms as described above, then the film 13 desirably is stripped off the reticle after completing FIB etching of the opaque defect(s). Alternatively, only the metal atoms are removed from the film 13, which subsequently can be left on the reticle. A metal-containing film is difficult to remove; aggressive chemistry is required, usually employing a corrosive fluorine, chlorine, or bromine gas, or a mixture of these gases. Also, because these gases also tend to erode the silicon membrane 11 itself, etching performed using these gases typically is selective and performed under controlled conditions. This treatment is not suited to mass production because it entails a large amount of labor.

In a representative process for performing reticle correction as described herein, a first step involves inspection of the pattern on the reticle. This step usually is performed using a defect-inspection apparatus. With the defect-inspection apparatus, the actual reticle pattern is compared with respective coordinate data for the elements of the pattern (such as from a reticle-pattern CAD database). A reticle defect is identified from a respective significant difference detected in the coordinates of the affected pattern element versus the corresponding CAD (computer-aided design) coordinate data for the particular element.

In a second step, the reticle is conveyed to a defect-correction apparatus, in which the target opaque defect on the reticle is identified and the required machining size is defined for correcting the defect. These tasks are accomplished by comparing the defect-coordinate data obtained during reticle inspection with corresponding coordinates as determined by the defect-correction apparatus.

In a third step, at the target opaque defect, the film 13 is selectively formed along the CAD-specified edge of the respective pattern element adjacent the opaque defect. The area in which the film 13 is applied desirably is at least 0.1 μm in width and 1.5 times the length of the defect on the membrane plane adjacent the edge of the affected pattern element. The thickness of the film 13 desirably is at least equal to the depth to which edge rounding would extend if the film 13 were not used.

In a fourth step, defect-correction machining is performed using the FIB and gas as described above. In a fifth step the size and shape of the site at which the opaque defect was corrected are evaluated and verified to confirm appropriate correction of the defect. In a sixth step, the reticle is suitably washed, after which it can be placed in a reticle cassette in an electron-beam microlithography apparatus (“EB stepper”).

The subject methods are further illustrated by the following examples.

A reticle blank having two exposure fields each comprising 100×80 exposure units (“subfields”) each measuring 1.13 mm square was produced from a reticle substrate prepared from an eight-inch diameter silicon wafer. The membrane portion of the reticle blank was 2 μm thick. A resist pattern, serving as an etching mask, was formed on the reticle blank by electron-beam direct writing of a resist layer applied to the membrane. According to the etching mask, the pattern was formed in the membrane by ICP-RIE (inductive-coupled plasma reactive ion etching).

After thus completing formation of the reticle, a transmission SEM (scanning electron microscope) image of the machined reticle pattern was obtained using the defect-inspection apparatus. Difference processing was performed of the CAD coordinate data versus the coordinate data for the pattern obtained from the SEM image. Defects were revealed from the results obtained from this data. Using the defect-inspection apparatus, a reflection SEM image also was obtained to complement the transmission SEM image. These images were subjected to optical-superposition processing to detect side-wall loci at which the inclination angle of the machined pattern was outside a specified range of 89 to 91°. Using these detection methods to inspect a region of the reticle, no side-wall-inclination defects were found. However, opaque defects were found.

In the defect-correction apparatus, the opaque defects were confirmed from a scanning-ion microscope (SIM) image taken from directly above the pattern. The respective coordinate data, as obtained using the defect-inspection apparatus, for the opaque defects were transferred to the defect-correction apparatus. In the defect-correction apparatus the respective machining locations for correcting the opaque defects were designated from this coordinate data.

From the coordinate data, the size of the locus containing the opaque defect was 0.15×0.15 μm. For this defect area, a FIB-induced protective film was formed on the corresponding region of the electron-scattering membrane having a length of 0.24 μm and a width of 0.15 μm just adjacent the opaque defect. The gas used for forming the protective film was tetramethylsilane supplied to the target site at a constant flow rate of 0.1 sccm, as determined using a temperature-regulated mass flow controller.

The beam current of the FIB was 10 pA to reduce implantation of gallium ions into the underlying silicon membrane. The induced film formed with this low-current beam comprised 60% silicon, 20% carbon, and slightly less than 20% hydrogen. The film thickness was about 0.2 μm.

After forming the protective film, the opaque defect was etched by FIB milling using a FIB at a beam current of 10 pA. The beam as incident on the defect was as sharply focused as possible (e.g., to several nm). Under these conditions, etching of the opaque defect required 1 minute 20 seconds to completion.

After completing correction of the opaque defects, the reticle was again inspected for defects using the defect-inspection apparatus. Optical evaluation of the reticle was performed after placing the reticle in an EB (electron-beam) stepper. The substrate was a silicon wafer on which a layer of resist (NEB-22 from Sumitomo Chemical) was applied. This resist was a chemically amplified negative-type resist, and the layer had a thickness of 0.25 μm. Using this resist, a gate layer was transferred and exposed. Pattern inspection of the exposed pattern was performed from measurements of a SEM image after developing the resist. The measurement results confirmed that the corrected loci produced corresponding regions of the exposed pattern having critical dimensions (CD) within specifications.

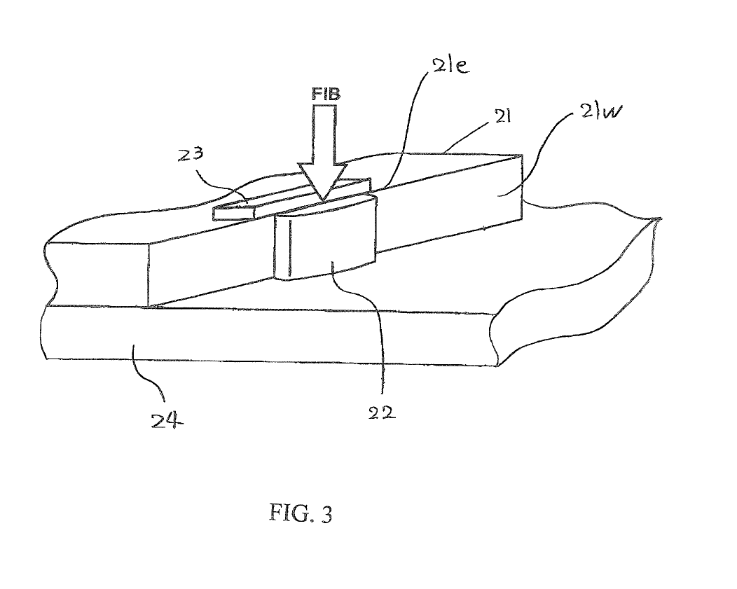

A second representative embodiment of a defect-correction method is depicted in FIG. 3, depicting an opaque defect 22 extending from a side wall 21w of a scattering body 21 at a site in a pattern element of a scattering-membrane reticle. As discussed above, the scattering body (usually made of tungsten (W) and having a thickness of about 100 nm) of a scattering-membrane reticle is an electron “scatterer.” The opaque defect 22 also is an electron scatterer. In contrast, the membrane 24 (usually made of silicon nitride (SiNₓ) and having a thickness of about 100 nm) is transmissive to electrons, with minimal scattering. Before machining the defect 22, a unit of protective film 23 is formed relative to the defect so as to mask the edge 21e of the scattering body 21 in the vicinity of the defect 22. The film 23 placed in this manner prevents damage to the scattering body 21 by the FIB during subsequent irradiation of the defect 22 by the FIB. By protecting the edge 21e, the verticality of the side wall 21w is maintained even after the defect 22 has been removed.

Using a defect-correction method according to this representative embodiment, machining the defect by the FIB must be stopped before the incident FIB strikes the membrane 24. Machining the defect 22 desirably is stopped when the thickness of residual defect 22 is less than 10 nm. Such a residual defect does not significantly diminish the electron-transmissivity of the underlying membrane 24. Also, the amount of heat generated in such a residual defect from absorption of incident electrons is about the same as the amount of heat generated in the underlying electron-transmissive membrane 24 from electron absorption. Hence, the residual defect 22 poses no problem in this regard, either.

A scattering-stencil reticle for IPL (ion-beam projection lithography) is constructed similarly to a scattering-stencil reticle for EPL, except that the thickness of the scattering membrane in the reticle for IPL is about 3 μm. With such a reticle, if the protective film is made of DLC (diamond-like carbon), then the protective film can remain on the reticle after completing FIB etching of the opaque defect(s). In other words, under such conditions, the protective film need not be stripped off the reticle before using the reticle for microlithography.

Whereas methods according to the invention are described above in connection with several representative embodiments, it will be understood that the methods are not limited to those embodiments. On the contrary, the subject methods include all modifications, alternatives, and equivalents as may be encompassed within the spirit and scope of the invention, as defined by the appended claims.

What is claimed is:

1. A method for correcting an opaque defect in a microlithography reticle, the reticle including charged-particle-scattering regions and relatively non-scattering regions arranged relative to each other so as to define a pattern that can be projection-transferred to a substrate using a charged particle beam, the method comprising:
detecting a location of an opaque defect on the reticle;
on the reticle, selectively forming a unit of a protective film at a pattern element in which the opaque defect is located, the unit of protective film being situated relative to the defect so as to provide a mask protecting an adjacent edge of the charged-particle-scattering region defining the affected pattern element, while leaving the defect vulnerable to a defect-removing influence; and
while using the unit of protective film as a mask that defines a desired corrected contour for the edge of the affected pattern element, exposing the opaque defect to the defect-removing influence so as to correct the opaque defect and restore the contour.

2. The method of claim 1, wherein the unit of protective film is left on the reticle after correcting the defect.

3. The method of claim 2, wherein the unit of protective film exhibits an amount of charged-particle absorption sufficiently low such that, after correcting the opaque defect, as the reticle is used in microlithography the residual unit of protective film does not cause significant local heating of the reticle when the affected pattern element is being irradiated for projection transfer.

4. The method of claim 1, further comprising the step, after the step of exposing the opaque defect, of removing the unit of protective film from the reticle before using the reticle for microlithography.

5. The method of claim 1, wherein the unit of protective film is an electron-scattering material and a poor absorber of incident electrons.

6. The method of claim 1, wherein the unit of protective film comprises a material selected from the group consisting of silicon compounds, carbon compounds, and mixtures thereof.

7. The method of claim 6, wherein the material further comprises metal atoms.

8. The method of claim 7, wherein the unit of protective film is applied to the reticle by local reaction of a film-forming gas and an organometallic gas irradiated with a focused ion beam or electron beam, the film-forming gas comprising a silicon compound, a carbon compound, or a mixture thereof.

9. The method of claim 6, wherein the step of forming the unit of protective film comprises supplying, at the affected pattern element, a film-forming gas comprising a silicon-compound gas, a carbon-compound gas, or a mixture thereof, while irradiating with a focused ion beam or electron beam.

10. The method of claim 1, wherein the unit of protective film is made of a material comprising silicon.

11. The method of claim 10, wherein the unit of protective film is applied to the reticle by local reaction of a first compound while irradiating with a focused ion beam or electron beam, the first compound being selected from the group consisting of organosilanes, halosilanes, carboxysilanes, ketoximesilanes, and alkoxysilanes.

12. The method of claim 11, wherein the unit of protective film is applied to the reticle by local reaction of a second compound along with the first compound while irradiating with the focused ion beam or electron beam, the second compound being an organometallic gas.

13. The method of claim 1, wherein the unit of protective film is made of a material comprising carbon.

14. The method of claim 13, wherein the unit of protective film is applied to the reticle by local reaction of a condensed polycyclic hydrocarbon while irradiating with a focused ion beam or electron beam.

15. The method of claim 14, wherein the unit of protective film is applied to the reticle by local reaction of an organometallic gas along with the condensed polycyclic hydrocarbon, while irradiating with the focused ion beam or electron beam.

16. The method of claim 1, wherein the defect-removing influence is focused-ion-beam etching.

17. The method of claim 1, wherein the reticle is a scattering-stencil reticle.

18. A method for correcting an opaque defect in a scattering-stencil reticle, the reticle including an electron-scattering membrane in which non-scattering through-holes define respective pattern elements of a pattern, the method comprising:
detecting an opaque defect on the reticle, the opaque defect extending from the membrane into a respective through-hole of a respective affected pattern element;
selectively forming a unit of a protective film on the membrane at the affected pattern element, the unit of protective film being situated relative to the opaque defect so as to provide a mask protecting an edge and side wall of the membrane at the respective through-hole defining the affected pattern element while leaving the opaque defect vulnerable to a defect-removing influence; and
while using the unit of protective film as a mask that defines a desired corrected contour for the edge and side wall, exposing the opaque defect to the defect-removing influence so as to correct the opaque defect and the contour of the membrane of the pattern element.

19. The method of claim 18, wherein the unit of protective film comprises a material selected from the group consisting of silicon compounds, carbon compounds, and mixtures thereof.

20. The method of claim 18, wherein the material further comprises metal atoms.

21. The method of claim 18, wherein the unit of protective film is left on the reticle after correcting the defect.

22. The method of claim 18, wherein the unit of protective film is formed having a width, inward from the edge of the membrane, of at least 0.1 μm, a length of at least 1.5 times a length of the defect, and a thickness at least equal to a depth to which edge rounding would occur if the unit of protective film were not present while exposing the defect to a defect-removing influence.

23. In a charged-particle-beam microlithography method in which a pattern, defined by a scattering-stencil reticle including an electron-scattering membrane in which non-scattering through-holes define respective elements of the pattern, is projection-exposed onto a substrate, a method for correcting the reticle, the method comprising:
inspecting the pattern as defined on the reticle to produce respective defect-inspection data for the elements of the pattern as defined on the reticle;
comparing the defect-inspection data with respective design-specified coordinate data for the elements of the pattern;
for an affected pattern element producing defect-inspection data significantly different from respective design-specified coordinate data for the element, identifying an opaque defect in the pattern element and determining a machining size that would be required to correct the defect;
selectively forming a unit of a protective film at the affected pattern element, the unit of protective film being formed relative to the opaque defect so as to provide a local mask protecting an edge and side wall of the membrane at the respective through-hole defining the affected pattern element while leaving the opaque defect vulnerable to defect-correction machining; and
performing defect-correction machining of the opaque defect.

24. The method of claim 23, further comprising the step, after performing defect-correction machining, of confirming correction of the defect.

25. The method of claim 23, further comprising the step, after performing defect-correction machining, of washing the reticle.

26. In a charged-particle-beam microlithography method in which a pattern, defined by a scattering-membrane reticle including an electron-transmissive membrane on which scattering bodies define respective elements of the pattern, is projection-exposed onto a substrate, a method for correcting the reticle, the method comprising:
inspecting the pattern as defined on the reticle to produce respective defect-inspection data for the elements of the pattern as defined on the reticle;
comparing the defect-inspection data with respective design-specified coordinate data for the elements of the pattern;
for an affected pattern element producing defect-inspection data significantly different from respective design-specified coordinate data for the element, identifying an opaque defect in the pattern element and determining a machining size that would be required to correct the defect;
selectively forming a unit of a protective film at the affected pattern element, the unit of protective film being formed relative to the opaque defect so as to provide a local mask protecting an edge and side wall of the scattering body at the respective affected pattern element while leaving the opaque defect vulnerable to defect-correction machining; and
performing defect-correction machining of the opaque defect.

27. The method of claim 26, wherein the step of defect-correction machining is performed sufficiently to remove all the opaque defect except for a residual thickness of no more than 10 nm of the opaque defect on the membrane.

28. A method for correcting an opaque defect in a scattering-membrane reticle, the reticle including an electron-transmissive membrane on which respective scattering bodies define respective pattern elements of a pattern, the method comprising:
at an affected pattern element, detecting an opaque defect on the reticle, the opaque defect extending from a respective scattering body onto a respective adjacent region of the membrane;
selectively forming a unit of a protective film on the scattering body at the affected pattern element, the unit of protective film being situated relative to the opaque defect so as to provide a mask protecting an edge and side wall of the scattering body at the respective affected pattern element while leaving the opaque defect vulnerable to a defect-removing influence;
while using the unit of protective film as a mask that defines a desired corrected contour for the edge and side wall, exposing the opaque defect to the defect-removing influence so as to correct the opaque defect and the contour of the scattering body of the pattern element.

29. The method of claim 28, wherein the unit of protective film comprises a material selected from the group consisting of silicon compounds, carbon compounds, and mixtures thereof.

30. The method of claim 28, wherein the material further comprises metal atoms.

31. The method of claim 28, wherein the step of exposing the opaque defect to the defect-removing influence results in no more than a 10-nm thickness of the defect remaining on the underlying membrane.

32. A reticle in which an opaque defect has been corrected using the method recited in claim 1.

33. The reticle of claim 32, wherein the reticle is a scattering-stencil reticle.

34. The reticle of claim 32, wherein the reticle is a scattering-membrane reticle.

35. A reticle in which an opaque defect has been corrected using the method recited in claim 18.

36. A reticle in which an opaque defect has been corrected using the method recited in claim 23.

37. A reticle in which an opaque defect has been corrected using the method recited in claim 26.

38. A reticle in which an opaque defect has been corrected using the method recited in claim 28.
